(19) United States
(12) Patent Application Publication
(10) Pub. No.: US 2025/0361061 A1
(43) Pub. Date: Nov. 27, 2025

(54) TEAR GUIDE SEAL BAR, ENCLOSURE HAVING TEAR GUIDE DEFORMATION PATTERNS, AND METHOD FOR CREATING THE SAME

(71) Applicant: Illinois Tool Works Inc., Glenview, IL (US)

(72) Inventors: Jose Manuel Septien Rojas, Naperville, IL (US); Eric P. Plourde, Frankfort, IL (US); David J. Matthews, Gilman, IL (US)

(73) Assignee: Illinois Tool Works Inc., Glenview, IL (US)

(21) Appl. No.: 19/098,543

(22) Filed: Apr. 2, 2025

Related U.S. Application Data
(60) Provisional application No. 63/650,703, filed on May 22, 2024.

(51) Int. Cl. B65D 33/25; B29C 65/00; B29C 65/18; B29L 31/00; B31B 70/81; B31B 160/10; B65D 75/58

(52) U.S. Cl. CPC B65D 33/2508; B29C 65/18; B29C 66/81435; B29C 66/8511; B31B 70/8131; B65D 75/5827; B29L 2031/7129; B31B 2160/102

(57) ABSTRACT

An enclosure assembly can include panels on opposite sides of an interior volume, and a zipper assembly between the panels. The zipper assembly may include a tear strip that can be pulled and tear through one of the panels and create an opening through which the zipper assembly is accessible. This panel can include a deformation pattern formed from thinned out areas of the panel that one or more of overlap or do not overlap the tear strip. The deformation pattern can reduce a pulling force needed to tear through the panel within the deformation pattern relative to outside the deformation pattern.

### CROSS-REFERENCE TO RELATED APPLICATIONS

This application claims priority to U.S. Provisional Application No. 63/650,703 (filed 22 May 2024), the entire disclosure of which is incorporated herein by reference.

### BACKGROUND

### Technical Field

The subject matter described herein relates to enclosures, such as bags, pouches, packages, and the like, having a tear strip that is used to tear an opening through a panel of the package.

### Discussion of Art

Some enclosures can include tear strips that are pulled to tear a hole through a panel in the enclosure. For example, flexible bags, pouches, and the like, may have a tear strip having an end or a tab that is accessible through a small opening in the front of the enclosure, with the remainder of the tear strip beneath a front panel of the bag or pouch. A consumer can grasp this end or tab and pull the tear strip. This causes the tear strip to tear through the front panel of the enclosure and provide an opening into the enclosure. Some enclosures may have a zipper assembly beneath this opening that can allow the consumer to repeatedly open and re-seal the enclosure beneath the tear strip opening. For example, the zipper assembly may have opposing flanges with interlocking bodies that repeatedly mate with each other to seal the enclosure closed, and that can be repeatedly pulled apart from each other to open the enclosure. This can help maintain freshness or otherwise protect any product contained in the enclosure beneath the zipper assembly after the tear strip is used to create the opening above the zipper assembly.

But one problem with tear strips is that the tear strips may not tear in a perfectly straight line that is above and parallel to the zipper assembly. For example, the tear strip may be pulled at an angle or otherwise create a tear that does not remain above the zipper assembly. This can cause the opening torn by the tear strip to cross over and tear through the zipper assembly. This, in turn, can prevent the zipper assembly from being used to repeatedly re-seal the enclosure. The product contained in the enclosure may risk spoilage due to this inability to seal the enclosure.

A need may exist for an enclosure having a tear strip that decreases or eliminates the shortcomings described above.

### BRIEF DESCRIPTION

In one example, a seal bar for sealing a panel of an enclosure assembly to a zipper assembly inside the enclosure assembly is provided. The seal bar can include a body configured to be pressed into the panel of the enclosure assembly. The body can have an engagement surface that contacts the panel. The seal bar can include protrusions extending outward from the engagement surface of the body in areas of the engagement surface of the body that are pressed against a portion of the panel that is over a tear strip of the zipper assembly. The protrusions can create a deformation pattern in the panel along a length of the tear strip that confines tearing of the panel by the tear strip to within the deformation pattern.

An enclosure assembly can include first and second panels on opposite sides of an interior volume, and a zipper assembly between the first and second panels. The zipper assembly can include a first flange coupled with the first panel and a second flange coupled with the second panel. The first and second flanges can have protruding interlocking bodies that can repeatedly mate and separate from each other to repeatedly seal and open the interior volume. The zipper assembly may include a tear strip that can be pulled and tear through the first panel and create an opening through which the zipper assembly is accessible. The first panel can include a deformation pattern formed from thinned out areas of the first panel that one or more of overlap or do not overlap the tear strip. The deformation pattern can reduce a pulling force needed to tear through the first panel within the deformation pattern relative to outside the deformation pattern.

A method may include pressing a seal bar into a first panel of an enclosure assembly that also includes a second panel and a zipper assembly that includes a tear strip and that is between the first panel and the second panel, the seal bar including protrusions on an engagement surface of the seal bar that contacts the first panel, and forming a deformation pattern in the first panel using the protrusions. The deformation pattern can thin out locations of the first panel that are over the tear strip and reduce a force required to tear the first panel relative to areas outside of the deformation pattern.

### BRIEF DESCRIPTION OF THE DRAWINGS

The inventive subject matter may be understood from reading the following description of non-limiting embodiments, with reference to the attached drawings, wherein below:

FIG. 1 illustrates one example of an enclosure assembly;

FIG. 2 illustrates a zipper assembly of the enclosure assembly shown in FIG. 1;

FIG. 3 illustrates a cross-sectional view of one example of a tear guide seal bar;

FIG. 4 illustrates a perspective view of seal bar 302 shown in FIG. 3;

FIG. 5 illustrates a portion of one example the enclosure assembly with a deformation pattern;

FIG. 6 illustrates a perspective view of another example of a tear guide seal bar;

FIG. 7 illustrates a portion of the enclosure assembly with another example of a deformation pattern;

FIG. 8 illustrates a perspective view of another example of a tear guide seal bar;

FIG. 9 illustrates a portion of the enclosure assembly with another example of a deformation pattern; and

FIG. 10 illustrates a flowchart of one example of a method for forming tear guide deformation patterns in an enclosure assembly.

### DETAILED DESCRIPTION

One or more examples of the inventive subject matter described herein relate to enclosures having tear guiding deformation patterns in a panel of the enclosures that covers the tear strip. These deformation patterns can modify the panel in a localized area over the tear strip. The deformation patterns can reduce the force or effort that is required to tear the enclosure panel. As a result, pulling on the tear strip preferentially tears through the portion(s) of the panel having the deformation pattern instead of the portion(s) of the panel not having the deformation pattern. The deformation pattern can be limited in size to prevent the tear strip from tearing the panel through or over the zipper assembly. Additionally, examples of seal bars that can be used to create the deformation patterns are described, as well as methods for creating the deformation patterns.

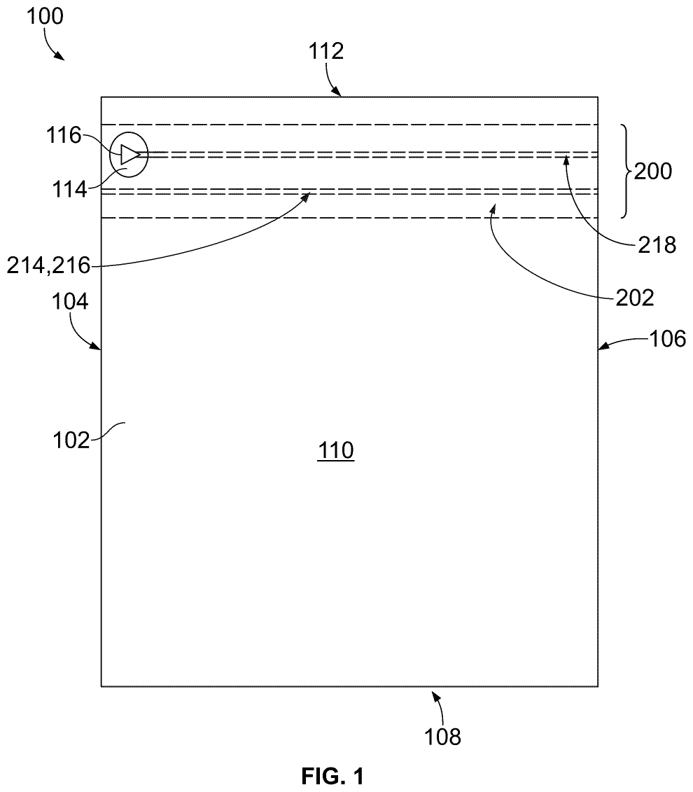

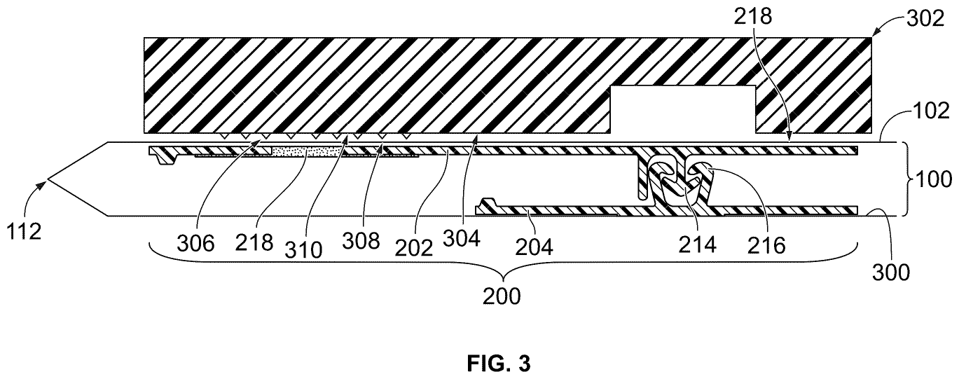

FIG. 1 illustrates one example of an enclosure assembly 100. The enclosure assembly 100 can represent a bag, package, or the like. The enclosure assembly 100 includes a first panel 102 coupled with a second panel (not visible in FIG. 1 but labeled as second panel 300 in FIG. 3) along at least three sides, edges, or interfaces 104, 106, 108. Optionally, the enclosure assembly 100 may include gusseted sides between the first panel 102 and the second panel. For example, additional side panels may extend from the first panel 102 to the back panel along one or both of the side edges or interfaces 104, 106. The panels of the enclosure assembly 100 can enclose an interior volume 110 of the enclosure assembly 100 in which a product can be stored. A top edge 112 of the enclosure assembly 100 may be closed. For example, the top edge 112 may be closed with the first and second panels coupled with each other along the top edge 112.

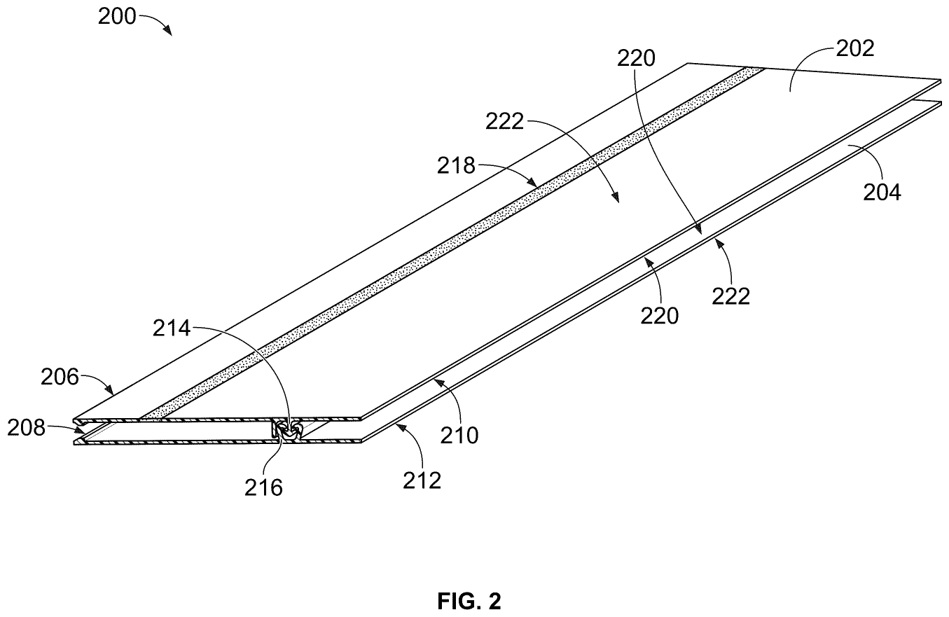

With continued reference to the enclosure assembly 100 shown in FIG. 1, FIG. 2 illustrates a zipper assembly 200 of the enclosure assembly 100. The zipper assembly 200 includes opposing flanges 202, 204 that may be coupled with one or both of the first and second panels of the enclosure assembly 100. In the illustrated example, the flanges 202, 204 are the same size. For example, each of the flanges 202, 204 may have the same height in that a top edge 206, 208 of each of the flanges 202, 204 is the same distance from the top edge 112 of the enclosure assembly 100 as each other, and an opposite, bottom edge 210, 212 of each of the flanges 202, 204 is the same distance from the bottom edge 108 of the enclosure assembly 100 as each other. Each of the flanges 202, 204 may be coupled with (e.g., adhered to) one of the panels of the enclosure assembly 100. For example, a first flange 202 may be adhered to an inside surface of the first panel 102 of the enclosure assembly 100 and the second flange 204 may be adhered to an inside surface of the second panel of the enclosure assembly 100.

In another example, the flanges 202, 204 may be differently sized. For example, the flanges 202, 204 may have different heights in that the top edge 206, 208 of one of the flanges 202, 204 is a shorter distance from the top edge 112 of the enclosure assembly 100 than the other flange 204, 202. Each of the flanges 202, 204 may be coupled with one of the panels of the enclosure assembly 100, as described above. Optionally, both flanges 202, 204 may be adhered to the same panel (e.g., the first panel 102) of the enclosure assembly 100.

Each of the flanges 202, 204 includes a panel side or surface 222 and an opposite interlocking side or surface 220. The panel sides 222 of the flanges 202, 204 are sealed to the inner surfaces of the panels 102, 300 of the enclosure assembly 100. The interlocking sides 220 of the flanges 202, 204 face each other. The flanges 202, 204 include interlocking elements 214, 216 that protrude from the interlocking sides 220 of the flanges 202, 204. The interlocking elements (or bodies) 214, 216 can be pressed together to engage and interlock with each other to close the interior volume 110 of the enclosure assembly 100. The interlocking elements 214, 216 can be pulled apart from each other to disengage from each other and open the interior volume 110 of the enclosure assembly 100. In the illustrated example, the interlocking element 214 is shown as a male member that is received into the female member of the interlocking element 216. Alternatively, the interlocking element 214 and/or 216 may have another shape. The interlocking elements 214, 216 can mate with each other and separate from each other multiple times to provide for a resealable opening into the interior volume 110 of the bag assembly 100.

In the illustrated example, the first flange 202 includes a tear strip 218. The tear strip 218 can be included in the first flange 202 (e.g., co-extruded with or formed inside the first flange 202) or can be attached to the surface or edge of the first flange 202. The tear strip 218 can be made from a material that differs from, and is stronger than, the material from which the flanges 202, 204 are made. For example, the flanges 202, 204 may be formed from low density polyethylene (LDPE) while the tear strip 218 is formed from high density polyethylene (HDPE), polypropylene (PP), or a cyclic olefin copolymer (COC). The tear strip 218 can release from the first flange 202 either by tearing or pealing. When the first flange 202 is covered by the first panel 102 of the enclosure assembly 100, the tear strip 218 is pulled to tear through the first panel 102 and create an opening in the first panel 102. This can allow a user or consumer to access the interlocking elements 214, 216 to pull and separate the interlocking elements 214, 216 and gain access to the interior volume 110 of the enclosure assembly 100.

The first panel 102 of the bag assembly 100 may include an access hole 114 through which the tear strip 218 is accessible from outside the first panel 102 of the enclosure assembly 100. The remainder of the tear strip 218 may be inaccessible from outside the enclosure assembly 100 as this remainder of the tear strip 218 is between the first panel 102 and the first flange 202 of the zipper assembly 200. This access hole 114 may only extend through the first panel 102 of the enclosure assembly 100 and the first flange 202 of the zipper assembly 200. The access hole 114 may not extend through the second flange 204 of the zipper assembly 200 or the second panel of the enclosure assembly 100.

A punch may be used to form the access hole 114 in the enclosure assembly 100 and in the zipper assembly 200. This punch may remove part, but not all, of the first flange 202, and may leave part of the first flange 202 connected with the tear strip 218. This part of the first flange 202 may be left to form a pull tab 116 that can be grasped by the user or consumer. For example, the pull tab 116 formed by a portion of the first flange 202 may be connected with the tear strip 218 by cutting the first flange 202 around the pull tab 116. This pull tab 116 may then be pulled by the user or consumer, thereby also pulling the tear strip 218. The tear strip 218 then separates from the first flange 202, tears through the first panel 102 of the enclosure assembly 100, and thereby provides access to the interlocking elements 214, 216. The tear strip 218 and first flange 202 are shown in FIG. 2 prior to cutting the first flange 202 with the hole punch to form the pull tab 116.

Optionally, the punch may be used to cut through both the first and second flanges 202, 204 in the zipper assembly 200. This can result in the pull tab 116 being formed from part of the first flange 202 with part of the second flange 204 also having the shape of the pull tab 116 cut through the second flange 204.

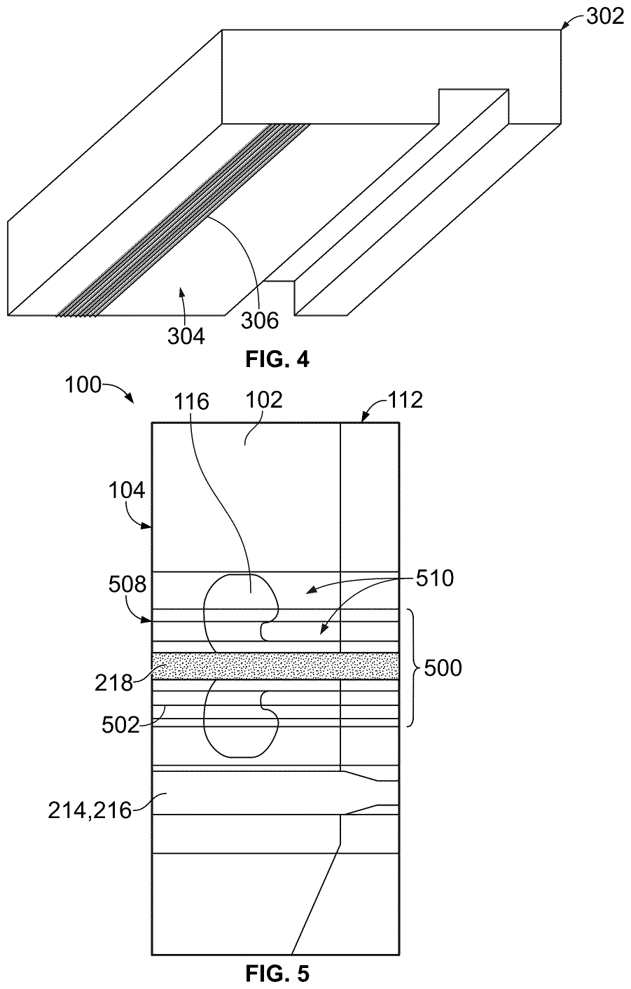

FIG. 3 illustrates a cross-sectional view of one example of a tear guide seal bar 302 sealing the first panel 102 of the enclosure assembly 100 to the zipper assembly 200 while also creating a tear guide deformation pattern 500 shown in FIG. 5. FIG. 4 illustrates a perspective view of the seal bar 302 shown in FIG. 3. FIG. 5 illustrates a portion of one example the enclosure assembly 100 after the seal bar 302 has created the deformation pattern 500 in the first panel 102 of the enclosure assembly 100.

The seal bar 302 is a body that is heated and pressed onto the first panel 102 of the enclosure assembly 100. The heat and pressure from an engagement side 304 of the seal bar 302 on the first panel 102 can melt or fuse the portion of the first panel 102 that is engaged by the engagement side 304 of the seal bar 302 to the panel side 222 of the first flange 202.

As shown, the engagement side 304 of the seal bar 302 may include several protrusions 306. The protrusions 306 are shown as having sharp ends or tips, but alternatively may have rounded ends or tips. The protrusions 306 dig into the first panel 102 of the enclosure assembly 100 as the seal bar 302 is pressed into the first panel 102 to seal the first panel 102 to the first flange 202 of the zipper assembly 200. The protrusions 306 may deform the first panel 102 differently than the remainder of the seal bar 302. For example, the remainder of the seal bar 302 outside of the protrusions 306 may be flat or recessed (e.g., in areas over the interlocking bodies 214, 216). This remainder of the seal bar 302 is flat and does not form any deformation pattern within the first panel 102. The protrusions 306, on the other hand, create the deformation pattern 500 in the first panel 102, as shown in FIG. 5. This deformation pattern 500 can make some locations 308 of the first panel 102 thinner than other areas 310 of the first panel 102 that are between the protrusions 306 (or outside of the protrusions 306).

As shown in FIGS. 3 and 4, the protrusions 306 are bodies (e.g., sharp-tipped or triangle-shaped bodies) that are elongated in directions that are parallel to each other. This causes the seal bar 302 to form the deformation pattern 500 as a series of parallel lines 502 in the first panel 102 of the enclosure assembly 100. Alternatively, the protrusions 306 may be undulating bodies that form the deformation pattern 500 as a series of undulating waves that are parallel to each other or that intersect or cross-over each other.

The protrusions 306 may deform the first panel 102 of the enclosure assembly 100 may thin out (e.g., reduce the thickness of) the first panel 102 in the thinner locations 308 without cutting through the first panel 102. Alternatively, one or more of the protrusions 306 may cut through the first panel 102. The protrusions 306 may engage the first panel 102 and create the deformation pattern 500 of the thinner locations 308 in areas that coincide with (e.g., are over) the tear strip 218, as shown in FIG. 5. This makes those areas of the first panel 102 easier to tear than the areas of the first panel 102 that are outside of the deformation pattern 500.

The deformation pattern 500 can be created in areas of the first panel 102 that are desired to be torn by the tear strip 218 and the deformation pattern 500 may not be created in other areas of the first panel 102 that are not desired to be torn by the tear strip 218. For example, the deformation pattern 500 may not extend up to the top edge 112 of the enclosure assembly 100 (shown in FIG. 1) or downward to the portion of the first panel 102 that lies over the interlocking bodies 214, 216 of the zipper assembly 200 (shown in FIGS. 2 and 3).

The locations 308 of the first panel 102 in the deformation pattern 500 make the panel 102 easier to tear when compared with the thicker areas 310 of the first panel 102 that are outside of the deformation pattern 500. For example, pulling on the tear strip 218 may impart a force on the first panel 102. This force may tear through the locations 308 in the panel 102 before tearing through thicker locations or areas outside of the locations 308 as the thinned-out panel 102 in the locations 308 is easier to tear than areas outside of the locations 308.

The deformation pattern 500 may be in areas of the first panel 102 that overlap the tear strip 218. For example, the deformations may be created in areas of the first panel 102 that overlap only the tear strip 218 and not areas that do not overlap the tear strip 218. As another example, the deformation pattern 500 may be in areas of the first panel 102 that overlap the tear strip 218 (“overlapping areas”) and in areas of the first panel 102 that do not overlap the tear strip 218 (“non-overlapping areas”). These non-overlapping areas may be above the tear strip 218 (e.g., between the tear strip 218 and the top edge 112 of the enclosure assembly 100). Optionally, these non-overlapping areas may be below the tear strip 218 (e.g., between the tear strip 218 and the interlocking bodies 216, 218). As another example, the deformation pattern 500 may be in areas of the first panel 102 that overlap the tear strip 218 and that are above and below the tear strip 218. As another example, the deformation pattern 500 may be in areas of the first panel 102 that do not overlap the tear strip 218, but that are only above and below the tear strip 218 (e.g., only in the non-overlapping areas of the first panel 102).

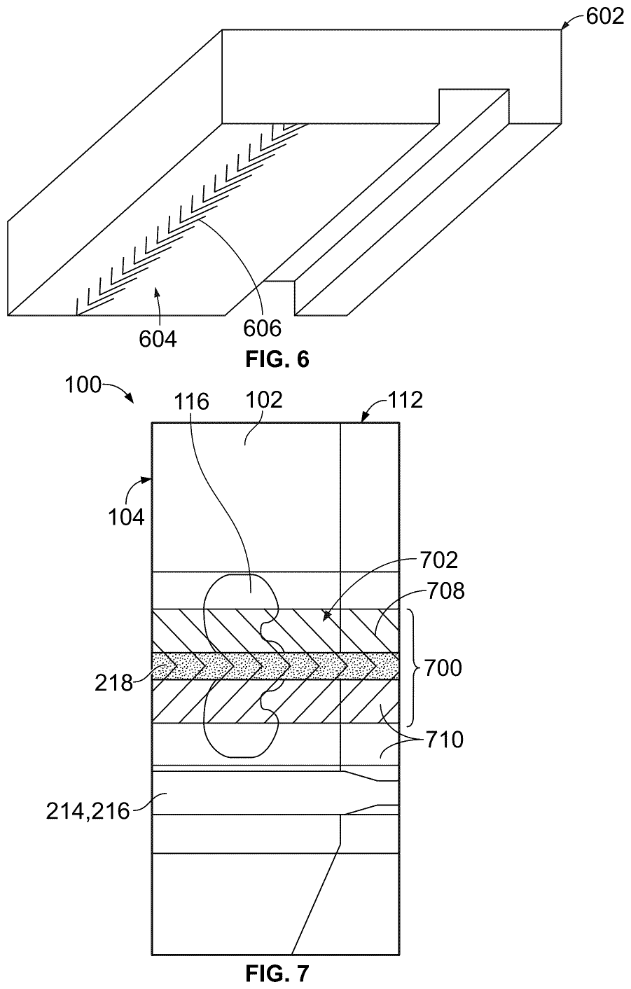

FIG. 6 illustrates a perspective view of another example of a tear guide seal bar 602 that creates another example of a tear guide deformation pattern 700 shown in FIG. 7. FIG. 7 illustrates a portion of one example the enclosure assembly 100 after the seal bar 602 has created the deformation pattern 700 in the first panel 102 of the enclosure assembly 100.

The seal bar 602 is a body that is heated and pressed onto the first panel 102 of the enclosure assembly 100. As described above in connection with the seal bar 302 shown in FIG. 3, the heat and pressure from an engagement side 604 of the seal bar 602 on the first panel 102 can melt or fuse the portion of the first panel 102 that is engaged by the engagement side 604 of the seal bar 602 to the panel side 222 of the first flange 202 of the zipper assembly 200.

The engagement side 604 of the seal bar 602 may include several protrusions 606. The protrusions 606 may have sharp ends or tips, similar to the protrusions 306 shown in FIG. 3), but alternatively may have rounded ends or tips. The protrusions 606 dig into the first panel 102 of the enclosure assembly 100 as the seal bar 602 is pressed into the first panel 102 to seal the first panel 102 to the first flange 202 of the zipper assembly 200. The protrusions 606 may deform the first panel 102 differently than the remainder of the seal bar 602. For example, the remainder of the seal bar 602 outside of the protrusions 606 may be flat or recessed and not form any deformation pattern within the first panel 102. The protrusions 606, on the other hand, create the deformation pattern 700 in the first panel 102, as shown in FIG. 7. As described above, the deformation pattern 700 can make some locations 708 of the first panel 102 thinner than other areas 710 of the first panel 102 that are between the protrusions 606 (or outside of the protrusions 606).

In contrast to the protrusions 306 shown in FIG. 4, the protrusions 606 are bodies (e.g., sharp-tipped or triangle-shaped bodies) that form chevrons, or bodies in the shape of the letter V. The chevrons may not intersect each other, as shown in FIG. 6, but may be parallel or otherwise non-intersecting with each other. This causes the seal bar 602 to form the deformation pattern 700 as a series of parallel or non-intersecting chevrons 702 in the first panel 102 of the enclosure assembly 100. Alternatively, the chevrons 702 may intersect or cross over each other. For example, the chevrons 702 may merge with each other to form the deformation pattern 700 with a series of shapes of the letter X or a series of diamond shapes.

As described above, the protrusions 606 may deform the first panel 102 of the enclosure assembly 100 by thinning out the first panel 102 in the thinner locations 708 without cutting through the first panel 102. Alternatively, one or more of the protrusions 606 may cut through the first panel 102. The protrusions 606 may engage the first panel 102 and create the deformation pattern 700 of the thinner locations 708 in areas that coincide with (e.g., are over) the tear strip 218, as shown in FIG. 7. This makes those areas of the first panel 102 easier to tear than the areas of the first panel 102 that are outside of the deformation pattern 700, as described above.

The deformation pattern 700 can be created in areas of the first panel 102 that are desired to be torn by the tear strip 218 and the deformation pattern 700 may not be created in other areas of the first panel 102 that are not desired to be torn by the tear strip 218. For example, the deformation pattern 700 may not extend up to the top edge 112 of the enclosure assembly 100 (shown in FIG. 1) or downward to the portion of the first panel 102 that lies over the interlocking bodies 214, 216 of the zipper assembly 200 (shown in FIGS. 2 and 3).

The locations 708 of the first panel 102 in the deformation pattern 700 make the panel 102 easier to tear when compared with the thicker areas 710 of the first panel 102 that are outside of the deformation pattern 700, as described above. The chevrons 702 in the deformation pattern 700 may be oriented in a direction along the direction in which the tear strip 218 is pulled. For example, the chevrons 702 in the deformation pattern 700 may include lines 704 that dovetail or are angled toward each other along or in the same direction that the tear strip 218 is pulled. This can assist with ensuring that the tear strip 218 tears along this same direction instead of downward toward the interlocking bodies 214, 216 of the tear strip 218 as the chevrons 702 may guide or direct the pulling force into a line that is over, along, or parallel to the tear strip 218.

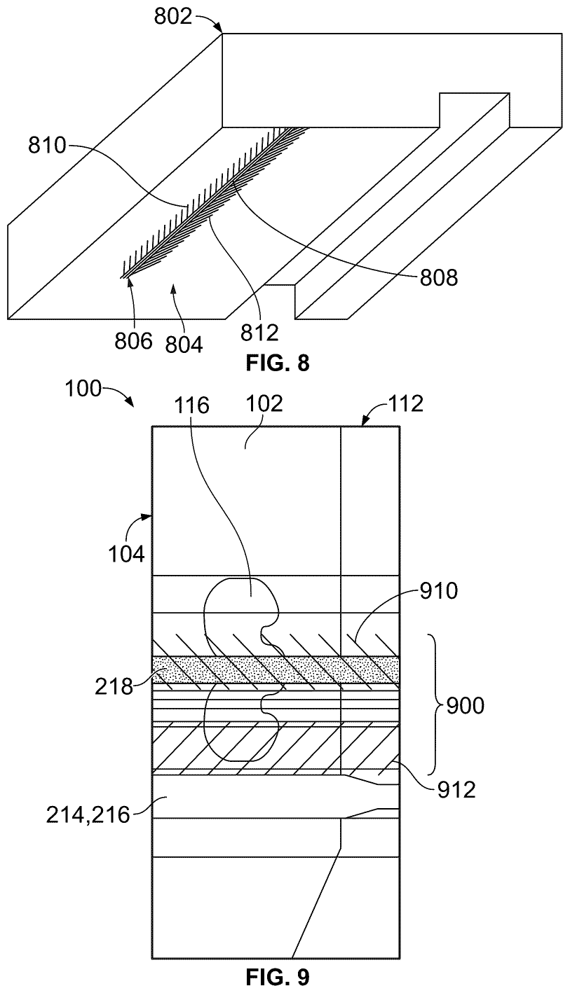

FIG. 8 illustrates a perspective view of another example of a tear guide seal bar 802 that creates another example of a tear guide deformation pattern 900 shown in FIG. 9. FIG. 9 illustrates a portion of one example the enclosure assembly 100 after the seal bar 802 has created the deformation pattern 900 in the first panel 102 of the enclosure assembly 100.

The seal bar 802 is a body that is heated and pressed onto the first panel 102 of the enclosure assembly 100, as described above in connection with the other seal bars 302, 602 shown in FIGS. 3 and 6. The heat and pressure from an engagement side 804 of the seal bar 802 on the first panel 102 can melt or fuse the portion of the first panel 102 that is engaged by the engagement side 804 of the seal bar 802 to the panel side 222 of the first flange 202 of the zipper assembly 200.

The engagement side 804 of the seal bar 802 may include several protrusions 806. The protrusions 806 may have sharp ends or tips, or may have rounded ends or tips. The protrusions 806 dig into the first panel 102 of the enclosure assembly 100 as the seal bar 802 is pressed into the first panel 102 to seal the first panel 102 to the first flange 202 of the zipper assembly 200. The protrusions 806 may deform the first panel 102 differently than the remainder of the seal bar 802, as described herein.

In contrast to the protrusions 306, 606 of the seal bars 302, 602, the protrusions 806 are bodies that include several parallel lines 808 and several tapered lines 810, 812. The tapered lines 810 may be outside of and on opposite sides of the parallel lines 808. The tapered lines 810 on one side of the parallel lines 808 may be parallel to each other, the tapered lines 812 on the opposite side of the parallel lines 808 may be parallel to each other, and the lines 808 between the different sets of the tapered lines 810, 812 may be parallel to each other. The tapered lines 810 may be oriented along directions that intersect the directions in which the parallel lines 808 are oriented and/or directions in which the tapered lines 812 are oriented. The tapered lines 812 may be oriented along directions that intersect the directions in which the parallel lines 808 are oriented and/or directions in which the tapered lines 810 are oriented.

The tapered lines 810, 812 may form portions of the chevrons described above. For example, the tapered lines 810, 812 may dovetail toward each other. As described above, the tapered lines 810, 812 may be oriented toward each other along directions that are over or parallel to the tear strip 218. The protrusions 806 may deform the first panel 102 of the enclosure assembly 100 by thinning out the first panel 102 in thinner locations 908 without cutting through the first panel 102. Alternatively, one or more of the protrusions 806 may cut through the first panel 102. The protrusions 806 may engage the first panel 102 and create the deformation pattern 900 in areas that coincide with (e.g., are over) the tear strip 218, as shown in FIG. 9. This makes those areas of the first panel 102 easier to tear than the areas of the first panel 102 that are outside of the deformation pattern 900, as described above.

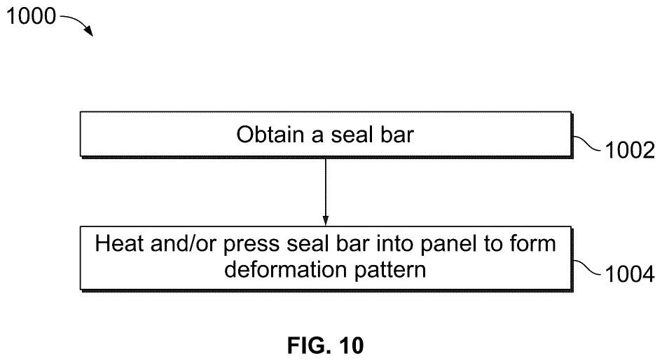

FIG. 10 illustrates a flowchart of one example of a method 1000 for forming tear guide deformation patterns in an enclosure assembly. The method 1000 can be used to create one or more of the deformation patterns in enclosure assemblies described herein. At 1002, a seal bar is obtained. The seal bar may have protrusions extending from an engagement surface of the seal bar. These protrusions may be in a pattern or arrangement that is desired to create the deformation pattern in the enclosure assembly. At 1004, the seal bar is heated and pressed into a panel of the enclosure assembly. The seal bar may be externally heated by a heating element or may include (or be connected with) a heating element that heats the seal bar. The engagement side of the seal bar may be pressed (e.g., forced downward into) the panel of the enclosure assembly. This both seals the panel to a flange of a zipper assembly of the enclosure assembly, and also forms a deformation pattern in the panel. As described above, this deformation panel can reduce the force needed to tear the panel using a tear strip of the zipper assembly. The deformation pattern can be positioned and oriented to cause tearing of the panel to extend in direction(s) that are parallel to, or more parallel to than perpendicular to, the direction in which the tear strip is oriented or elongated.

In one example, a seal bar for sealing a panel of an enclosure assembly to a zipper assembly inside the enclosure assembly is provided. The seal bar can include a body configured to be pressed into the panel of the enclosure assembly. The body can have an engagement surface that contacts the panel. The seal bar can include protrusions extending outward from the engagement surface of the body in areas of the engagement surface of the body that are pressed against a portion of the panel that is over a tear strip of the zipper assembly. The protrusions can create a deformation pattern in the panel along a length of the tear strip that confines tearing of the panel by the tear strip to within the deformation pattern.

The protrusions may create thinned out locations of the panel of the enclosure assembly within the deformation pattern. The protrusions can create the thinned out locations of the panel that require less force to tear through than other locations of the panel. The protrusions can be arranged as plural parallel lines protruding from the engagement surface of the seal bar. Additionally or alternatively, the protrusions can be arranged as plural chevrons protruding from the engagement surface of the seal bar. The protrusions arranged as the chevrons may not intersect each other. The protrusions arranged as the chevrons can dovetail in one or more directions that are parallel to the tear strip.

Optionally, the protrusions can be arranged as plural parallel lines and plural tapered lines on opposite sides of the parallel lines. The tapered lines on the opposite sides of the parallel lines can be oriented toward the parallel lines along a length of the tear strip.

An enclosure assembly can include first and second panels on opposite sides of an interior volume, and a zipper assembly between the first and second panels. The zipper assembly can include a first flange coupled with the first panel and a second flange coupled with the second panel. The first and second flanges can have protruding interlocking bodies that can repeatedly mate and separate from each other to repeatedly seal and open the interior volume. The zipper assembly may include a tear strip that can be pulled and tear through the first panel and create an opening through which the zipper assembly is accessible. The first panel can include a deformation pattern formed from thinned out areas of the first panel that one or more of overlap or do not overlap the tear strip. The deformation pattern can reduce a pulling force needed to tear through the first panel within the deformation pattern relative to outside the deformation pattern.

The deformation pattern in the first panel can include plural parallel lines. The parallel lines may not be located in the first panel over the interlocking bodies of the zipper assembly. The deformation pattern in the first panel may only overlap the tear strip and may not overlap other areas of the first panel that are between the tear strip and a top edge of the first panel or between the tear strip and the interlocking bodies.

The deformation pattern can be in only other areas of the first panel that are (a) between the tear strip and a top edge of the first panel and (b) between the tear strip and the interlocking bodies, but does not overlap the tear strip. The deformation pattern in the first panel may include chevrons. The chevrons may not be located in the first panel over the interlocking bodies of the zipper assembly. The chevrons may not intersect each other.

Optionally, the deformation pattern can include plural parallel lines and plural tapered lines on opposite sides of the parallel lines. The tapered lines on the opposite sides of the parallel lines can be oriented toward the parallel lines along a length of the tear strip.

A method may include pressing a seal bar into a first panel of an enclosure assembly that also includes a second panel and a zipper assembly that includes a tear strip and that is between the first panel and the second panel, the seal bar including protrusions on an engagement surface of the seal bar that contacts the first panel, and forming a deformation pattern in the first panel using the protrusions. The deformation pattern can thin out locations of the first panel that are over the tear strip and reduce a force required to tear the first panel relative to areas outside of the deformation pattern.

The singular forms “a,” “an,” and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A seal bar for sealing a panel of an enclosure assembly to a zipper assembly inside the enclosure assembly, the seal bar comprising:
a body configured to be pressed into the panel of the enclosure assembly, the body having an engagement surface that contacts the panel; and
protrusions extending outward from the engagement surface of the body, the protrusions located in areas of the engagement surface of the body that are pressed against a portion of the panel that is over a tear strip of the zipper assembly, the protrusions configured to create a deformation pattern in the panel along a length of the tear strip, the deformation pattern configured to confine tearing of the panel by the tear strip to within the deformation pattern.

2. The seal bar of claim 1, wherein the protrusions are configured to create thinned out locations of the panel of the enclosure assembly within the deformation pattern.

3. The seal bar of claim 2, wherein the protrusions are configured to create the thinned out locations of the panel that require less force to tear through than other locations of the panel.

4. The seal bar of claim 1, wherein the protrusions are arranged as plural parallel lines protruding from the engagement surface of the seal bar.

5. The seal bar of claim 1, wherein the protrusions are arranged as plural chevrons protruding from the engagement surface of the seal bar.

6. The seal bar of claim 5, wherein the protrusions arranged as the chevrons do not intersect each other.

7. The seal bar of claim 5, wherein the protrusions arranged as the chevrons dovetail in one or more directions that are parallel to the tear strip.

8. The seal bar of claim 1, wherein the protrusions are arranged as plural parallel lines and plural tapered lines on opposite sides of the parallel lines.

9. The seal bar of claim 8, wherein the tapered lines on the opposite sides of the parallel lines are oriented toward the parallel lines along a length of the tear strip.

10. An enclosure assembly comprising:
first and second panels on opposite sides of an interior volume; and
a zipper assembly between the first and second panels, the zipper assembly including a first flange coupled with the first panel and a second flange coupled with the second panel, the first and second flanges having protruding interlocking bodies configured to repeatedly mate and separate from each other to repeatedly seal and open the interior volume, the zipper assembly including a tear strip configured to be pulled and tear through the first panel and create an opening through which the zipper assembly is accessible,
the first panel including a deformation pattern formed from thinned out areas of the first panel that one or more of overlap or do not overlap the tear strip, the deformation pattern configured to reduce a pulling force needed to tear through the first panel within the deformation pattern relative to outside the deformation pattern.

11. The enclosure assembly of claim 10, wherein the deformation pattern in the first panel includes plural parallel lines.

12. The enclosure assembly of claim 11, wherein the parallel lines are not located in the first panel over the interlocking bodies of the zipper assembly.

13. The enclosure assembly of claim 10, wherein the deformation pattern in the first panel only overlaps the tear strip and does not overlap other areas of the first panel that are between the tear strip and a top edge of the first panel or between the tear strip and the interlocking bodies.

14. The enclosure assembly of claim 10, wherein the deformation pattern in the first panel only other areas of the first panel that are (a) between the tear strip and a top edge of the first panel and (b) between the tear strip and the interlocking bodies, but does not overlap the tear strip.

15. The enclosure assembly of claim 10, wherein the deformation pattern in the first panel includes plural chevrons.

16. The enclosure assembly of claim 15, wherein the chevrons are not located in the first panel over the interlocking bodies of the zipper assembly.

17. The enclosure assembly of claim 15, wherein the chevrons do not intersect each other.

18. The enclosure assembly of claim 11, wherein the deformation pattern includes plural parallel lines and plural tapered lines on opposite sides of the parallel lines.

19. The enclosure assembly of claim 18, wherein the tapered lines on the opposite sides of the parallel lines are oriented toward the parallel lines along a length of the tear strip.

20. A method comprising:
pressing a seal bar into a first panel of an enclosure assembly that also includes a second panel and a zipper assembly that includes a tear strip and that is between the first panel and the second panel, the seal bar including protrusions on an engagement surface of the seal bar that contacts the first panel; and
forming a deformation pattern in the first panel using the protrusions, the deformation pattern thinning out locations of the first panel that are over the tear strip and reducing a force required to tear the first panel relative to areas outside of the deformation pattern.
